(19) United States
(12) Patent Application Publication
(10) Pub. No.: US 2020/0147827 A1
(43) Pub. Date: May 14, 2020

(54) Reversing device for improving the utilization of wind energy

(71) Applicant: Guangda Chen, Zhuji City (CN)

(72) Inventor: Guangda Chen, Zhuji City (CN)

(21) Appl. No.: 16/746,810

(22) Filed: Jan. 18, 2020

(30) Foreign Application Priority Data
Nov. 4, 2019 (CN) 2019110669876

(51) Int. Cl. B27C 1/00; B27C 1/14

(52) U.S. Cl. CPC B27C 1/002; B27C 1/14

(57) ABSTRACT

The invention discloses a shaving blade with adjustable shaving depth for a high-grade floor, which includes a machine body. The machine body is provided with a working cavity penetrating up and down, and an opening space is provided on the right wall of the working cavity. The bottom side of the wheel groove is provided with a fixed cavity on the left side of the wheel groove to open the power motor, thereby driving the motor shaft, the fifth bevel gear, the sixth bevel gear, the water pump shaft, and the cam to rotate. The device can automatically Adjust the depth and angle of the blade of the planer, so that when using a planer, woodworkers can automatically adjust the amount of the knife according to the actual situation, and then cooperate with the function of adjusting the angle of the blade to extend the life of the blade. During the process, the wood chips shaved off by the planer can be discharged out of the device through the removing device.

### CROSS-REFERENCES TO RELATED APPLICATIONS

The present application claims priority from Chinese application No. 2019108858117 filed on Sep. 19, 2019 which is hereby incorporated by reference in its entirety.

### TECHNICAL FIELD

The invention relates to the field of woodworking, in particular to a shaving blade with adjustable shaving depth for high-grade floors.

### BACKGROUND OF THE INVENTION

Nowadays, people's requirements for decoration are getting higher and higher, so the requirements of decoration masters are also getting higher and higher. When decorating wooden floors, some high-end floor decorations do not like to use ordinary flooring for decoration, and like to use log flooring. Decoration, but some log floors need to use a shaving knife to adjust the thickness of the log floor when in use;

However, the existing wood shaving blades can usually only adjust the depth of the shaving blade at one time, but cannot adjust the angle of the shaving blade, so that the life of the shaving blade cannot be guaranteed. When shaving wood floors, it is easy to be caught by wood chips, which makes the shaving smooth.

### BRIEF SUMMARY OF THE INVENTION

The object of the present invention is to provide a shaving blade with adjustable shaving depth for high-grade floors, so as to solve the problems raised in the background art mentioned above.

In order to achieve the above objective, the present invention provides the following technical solution: An adjustable shaving depth shaving blade for high-grade floors includes a machine body, and the machine body is provided with a working cavity penetrating up and down, and a right side wall of the working cavity An opening space is provided, and a wheel groove is provided on the bottom side of the body. A fixed cavity is provided on the left side of the wheel groove, the fixed cavity is in communication with the working cavity, and between the fixed cavity and the open space. A communication cavity is communicated, and a removing device for removing wood chips is provided between the open space and the wheel groove;

The removing device includes a wheel shaft rotatably mounted on the front and rear side walls of the wheel groove, a soft wheel is fixed on the wheel shaft, a first bevel gear is fixed on the front side of the wheel shaft, and a bottom wall of the open space is provided. A penetrating shaft is rotatably connected to the top wall of the wheel groove, and a second bevel gear meshing with the first bevel gear is fixed on the bottom side of the penetrating shaft, and the top side of the penetrating shaft is fixed. A third bevel gear, a horizontal axis is rotatably connected to the right wall of the opening space, and a fourth bevel gear meshing with the third bevel gear is fixed on the right side of the horizontal axis, and the left side of the horizontal shaft is fixed A long gear is fixed, a sliding slider is slidably connected in the opening space, a right side of the moving slider is provided with a fixed cavity opening to the right, and a left side of the moving slider is provided with an opening opening to the left. A gear shaft is rotatably connected between the right wall of the discharge cavity and the left wall of the fixed cavity, and an end gear meshing with the long gear is fixed on the right side of the gear shaft, and the gear A seventh bevel gear is fixed on the left side of the shaft, and a rotating shaft is rotatably connected to the front and rear side walls of the discharge cavity. The front side of the rotary shaft is provided with the solid seventh eighth bevel gear of the bevel gear, a rear side of the rotary shaft is provided with six small solid roller;

The fixing cavity is provided with a fixing device for fixing the blade, the left side wall of the working cavity is provided with an auxiliary cavity, the left side of the auxiliary cavity is provided with a driving cavity, and the left side of the driving cavity is provided with a hydraulic pipe. A hydraulic chamber is symmetrically connected to both ends of the hydraulic pipeline, and an adjusting device for adjusting a cutter angle is provided in the hydraulic chamber and the working chamber, and a stabilizing device is provided in the auxiliary chamber to make the adjusting device stable.

Based on the above technical solution, the fixing device includes a hydraulic cylinder fixedly installed on the right wall of the fixed cavity, and a fixed head slidingly connected to the fixed cavity is dynamically connected in the hydraulic cylinder, and the fixed head and A driving slider slidingly connected to the through cavity is connected between the moving sliders.

On the basis of the above technical solution, the adjusting device includes a power motor fixedly installed on the bottom wall of the driving cavity. A power motor shaft is connected to the power motor, and a fifth cone is fixed on the top side of the motor shaft. A gear, a water pump is fixed in the hydraulic pipeline, a water pump shaft for driving the water pump is provided in the water pump, the water pump shaft is rotatably connected with the left side wall of the driving cavity, and the middle side of the water pump shaft A sixth bevel gear that is meshed with the fifth bevel gear is fixed. A cam is fixed on the right side of the water pump shaft. Rotary shafts are rotatably connected to the front and rear side walls of the working chamber. A fixing plate is provided, and fixing blocks are symmetrically fixed on the left side of the fixing plate. Each of the fixing blocks is respectively hinged with a hydraulic rod, and hydraulic oil is arranged between the hydraulic rods on the upper and lower sides.

Based on the above technical solution, the stabilizing device includes a ladder block slidingly installed on the bottom wall of the driving cavity, a return spring is connected between the ladder block and the bottom wall of the driving cavity, and the left side of the ladder block is A driven plate is fixed on the surface. The driven plate is in contact with the cam. The upper and lower side walls of the auxiliary cavity are symmetrically slidably connected with clips. The clips and the auxiliary cavity are respectively tightly connected with each other. Compressing a spring, the upper and lower sides of the clamping strip are symmetrically provided with a clamping slot, and the limiting chute is slidingly connected to a limiting block in a vertical symmetry manner, and the limiting block can be slidably connected to the clamping slot. A limiting spring is connected between the left side wall of the auxiliary cavity and the right side wall of the driving cavity, and a clamping block that can abut the ladder block is slidingly connected.

Based on the above technical solution, a soft pad is fixed on the right side of the fixing plate, and the soft pad can fix the blade.

Based on the above technical solution, the small roller is made of rubber material.

Based on the above technical solution, the elasticity of the limit spring is smaller than the elasticity of the return spring.

Based on the above technical solution, the compression spring is always in a compressed state.

Based on the above technical solution, the handles are symmetrically fixed on the front and back sides of the body.

In summary, the beneficial effect of the present invention is that the device can automatically adjust the depth and angle of the planer blade, so that when the woodworker uses the planer, according to the actual situation, the amount of feed can be automatically adjusted, and then the angle of the blade can be adjusted. Function to extend the life of the blade;

At the same time, during the use of the device, the sawdust shaved off by the planer can be discharged out of the device through the removal device, so that the planer is not prone to seizure during use, so that the planer can ensure the use of the planer during work. Fluency.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

FIG. 1 is a schematic front structural view of an entire full-scale shaving blade with adjustable shaving depth for a high-grade floor according to the present invention; FIG.

FIG. 2 is a partially enlarged view of A in FIG. 1 of the present invention; FIG.

FIG. 3 is a partially enlarged view of a portion B in FIG. 1 of the present invention; FIG.

FIG. 4 is a top view of FIG. 1 of the present invention.

### DETAILED DESCRIPTION OF THE INVENTION

All features disclosed in this specification, or all disclosed methods or steps, other than mutually exclusive features and/or steps, may be combined in any manner.

Any feature disclosed in this specification (including any additional claims, abstract, and drawings), unless specifically stated, may be replaced by other equivalent or similar purpose alternative features. That is, unless specifically stated, each feature is just one example of a series of equivalent or similar features.

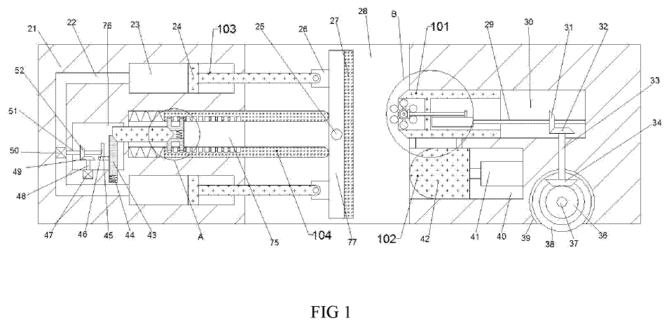

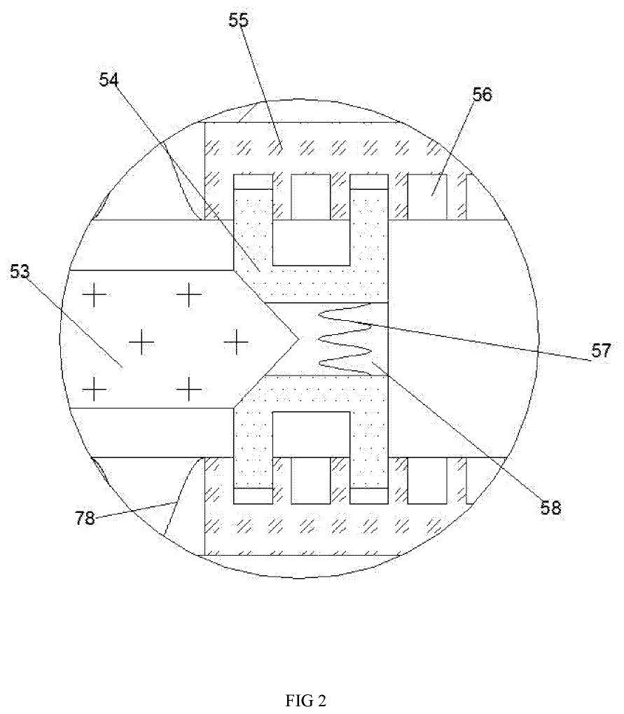

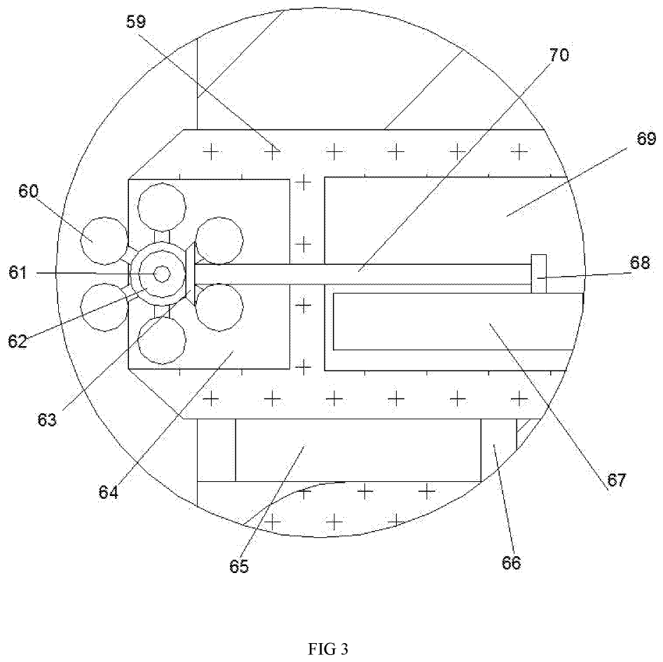

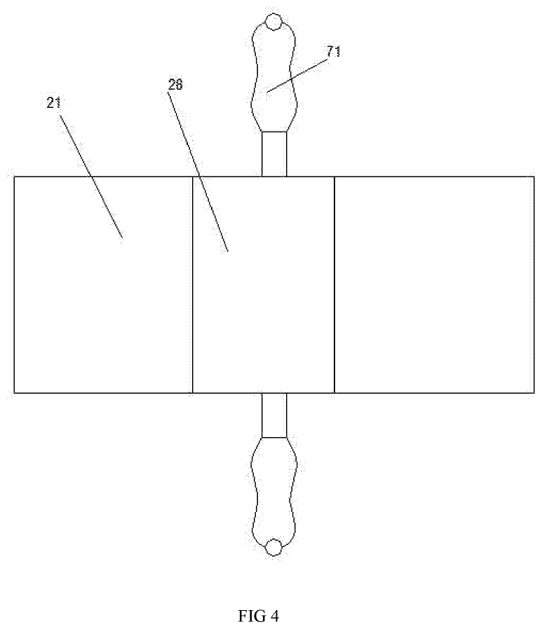

The present invention will be described in detail below with reference to FIGS. 1-4. Among them, for convenience of description, the orientation described below is defined as follows: the up-down, left-right, front-back, and up-down directions described below are consistent with the front-back, left-right, up-down, and down directions of the view direction of FIG. 1 is a front view of the device of the present invention, and the direction shown in FIG. 1 is the same as the front, rear, left, right, and up and down directions of the device of the present invention.

Please refer to FIGS. 1-4. An embodiment of the present invention provides a shaving blade with adjustable shaving depth for a high-grade floor. The right side wall of the working cavity 28 is provided with an opening space 30. The bottom side of the body 21 is provided with a wheel groove 39. The left side of the wheel groove 39 is provided with a fixing cavity 40. The fixing cavity 40 and the work A cavity 28 is in communication, and a communication cavity 65 is communicated between the fixed cavity 40 and the opening space 30. A removing device 101 for removing wood chips is provided between the opening space 30 and the wheel groove 39. The device 101 includes a wheel shaft 37 rotatably mounted on the front and rear side walls of the wheel groove 39. A soft wheel 38 is fixed on the wheel shaft 37. A first bevel gear 36 is fixed on the front side of the wheel shaft 37. The opening A through shaft 33 is rotatably connected between the bottom wall of the space 30 and the top wall of the wheel groove 39, and a second bevel gear 34 meshing with the first bevel gear 36 is fixed on the bottom side of the through shaft 33, A third bevel gear 32 is fixed on the top side of the penetrating shaft 33, and a horizontal shaft 29 is rotatably connected to the right wall of the opening space 30. A fourth bevel gear 31 meshing with the third bevel gear 32 is fixed on the right side of the shaft 29, and a long gear 67 is fixed on the left side of the horizontal shaft 29. A sliding connection is slidably connected to the opening space 30. Block 59, the right side of the moving slider 59 is provided with a fixed cavity 69 that opens to the right, and the left side of the moving slider 59 is provided with a discharge chamber 64 that opens to the left, and the right side wall of the discharge chamber 64 A gear shaft 70 is rotatably connected to the left wall of the fixed cavity 69. An end gear 68 meshing with the long gear 67 is fixed on the right side of the gear shaft 70, and the left side of the gear shaft 70 is fixed. A seventh bevel gear 63 is fixed, and a rotation shaft 61 is rotatably connected to the front and rear side walls of the discharge cavity 64. An eighth bevel gear 62 meshed with the seventh bevel gear 63 is fixed on the front side of the rotation shaft 61. Six small rollers 60 are fixed on the rear side of the rotating shaft 61, a fixing device 102 for fixing a blade is provided in the fixing cavity 40, and an auxiliary cavity 75 is provided on the left side wall of the working cavity 28. A driving chamber 76 is provided on the left side of the auxiliary chamber 75, and a hydraulic pipe 22 is provided on the left side of the driving chamber 76. The two ends of the hydraulic pipe 22 are in symmetrical communication with hydraulic pressure. 23, the hydraulic chamber 23 with the working chamber 28 is provided with adjusting means for adjusting the angle of the tool 103, the auxiliary chamber 75 is provided so that the stabilization device 103 can be stably regulating means 104.

In addition, in an embodiment, the fixing device 102 includes a hydraulic cylinder 41 fixedly installed on the right wall of the fixing cavity 40, and a fixing head slidingly connected to the fixing cavity 40 is dynamically connected to the hydraulic cylinder 41. 42. A driving slider 66 slidingly connected to the through cavity 65 is connected between the fixed head 42 and the moving slider 59, and the hydraulic cylinder 41 is opened, thereby driving the fixed head 42 to move to the left and thus Drive the driving slider 66 and the moving slider 59 to the left.

In addition, in one embodiment, the adjusting device 103 includes a power motor 47 fixedly installed on the bottom wall of the driving cavity 76, and a motor shaft 48 is dynamically connected to the power motor 47. A fifth bevel gear 49 is fixed on the side, and a water pump 50 is fixed in the hydraulic pipeline 22. The water pump 50 is provided with a water pump shaft 51 that drives the water pump 50 to start. The water pump shaft 51 and the driving chamber The left side wall of 76 is rotatably connected. A sixth bevel gear 52 meshing with the fifth bevel gear 49 is fixed on the middle side of the water pump shaft 51. A cam 46 is fixed on the right side of the water pump shaft 51. A rotating shaft 25 is rotatably connected to the front and rear side walls of the working cavity 28, and a fixing plate 77 is fixed on the rotating shaft 25. A fixing block 26 is symmetrically fixed on the left side of the fixing plate 77. A hydraulic rod 24 is hinged on the fixing block 26, and hydraulic oil is arranged between the hydraulic rods 24 on the upper and lower sides to open the power motor 47, thereby driving the motor shaft 48 and the fifth bevel gear 49. The sixth bevel gear 52, the water pump shaft 51, and the cam 46 rotate, thereby driving the The pump 50 is started to drive the hydraulic oil on one side to the other side through the water pump 50, so that the hydraulic rod 24 on one side moves to the left and the hydraulic rod 24 on one side moves to the right, so that The fixing plate 77 is rotated to adjust the angle.

In addition, in one embodiment, the stabilization device 104 includes a ladder block 43 slidingly mounted on the bottom wall of the driving cavity 76, and a return spring 44 is connected between the ladder block 43 and the bottom wall of the driving cavity 76. A driven plate 45 is fixed on the left side of the ladder block 43, the driven plate 45 is in contact with the cam 46, and upper and lower side walls of the auxiliary cavity 75 are symmetrically connected with a clamping strip 55. Compression springs 78 are respectively connected between the clamping strip 55 and the auxiliary cavity 75. The upper and lower sides of the clamping strip 55 are symmetrically provided with clamping grooves 56. The limiting slide grooves 58 are symmetrically slidingly connected to the limiting block 54 up and down. The limiting block 54 can be slidably connected to the card slot 56, a limiting spring 57 is connected between the limiting block 54, a left side wall of the auxiliary cavity 75 and a right side wall of the driving cavity 76. A sliding block 53 is slidably connected to the ladder block 43. When the cam 46 rotates, the rotation speed of the cam 46 is faster, thereby driving the driven plate 45 and the ladder block 43. Always press down, so that the ladder block 43 moves downward, so that the ladder block 43 and the clamping block 53 are disengaged from each other, and the limit spring 57 rebounds, so that the limiting block 54 is disengaged from the slot 56. At this time, the rotation of the fixing plate 77 can drive the clamping bar 55 to adjust left and right. When the power motor 47 is turned off, the cam 46 stops rotating, thereby resetting the return spring 44 and pushing the clamping block 53 to the top right, so that the limiting block 54 is re-engaged in the clamping strip 55 to complete stability.

In addition, in an embodiment, a soft pad 27 is fixed on the right side of the fixing plate 77, and the soft pad 27 can fix the blade.

In addition, in one embodiment, the small roller 60 is made of a rubber material, which can prevent the blade from being damaged due to collision with the blade.

In addition, in one embodiment, the elasticity of the limit spring 57 is smaller than the elasticity of the return spring 44.

In addition, in one embodiment, the compression spring 78 is always in a compressed state.

In addition, in one embodiment, grips 71 are fixed on the front and back sides of the body 21 symmetrically.

When the blade needs to be fixed, the power motor 47 is turned on, thereby driving the motor shaft 48, the fifth bevel gear 49, the sixth bevel gear 52, the water pump shaft 51, and the cam 46 to rotate, so that when the cam 46 rotates, the cam 46 The speed of rotation is fast, so that the driven plate 45 and the ladder block 43 are always pressed downward, so that the ladder block 43 moves downward, so that the ladder block 43 and the clamping block 53 are disengaged from each other, and the limit spring 57 rebounds, thereby The stopper block 54 is released from the slot 56. At this time, the rotation of the fixing plate 77 can drive the clamping bar 55 to adjust left and right, thereby driving the water pump 50 to start, and thereby driving the hydraulic oil on one side to the other side through the water pump 50, thereby making one side The hydraulic lever 24 moves to the left, and the hydraulic lever 24 on one side moves to the right, so that the fixed plate 77 is rotated to adjust the angle, and then the power motor 47 is turned off, and the cam 46 stops rotating, so that the return spring 44 is reset, and the clamping block 53 is reset. Go to the top right, so that the stopper 54 is re-engaged in the clamping bar 55 to complete the stable fixing plate 77, and then attach the blade to the right side of the cushion 27 with the cutting edge facing downwards, and manually adjust the blade feed amount. Then open the hydraulic cylinder 41, Thus, the fixed head 42 is driven to move to the left, thereby driving the slider 66 and the moving slider 59 to move to the left, thereby driving the small roller 60 to move to the left, so that the small roller 60 is in contact with the blade, and the blade is fixed;

When you need to plan the wood, hold the grip 71 with both hands, and then make the blade in the body 21 abut the wooden board, and then push forward, so as to drive the soft wheel 38, the axle 37, the first bevel gear 36, and the second bevel gear 34. Through shaft 33, third bevel gear 32, fourth bevel gear 31, transverse shaft 29, long gear 67, end gear 68, gear shaft 70, seventh bevel gear 63, eighth bevel gear 62, rotation shaft 61, The small roller 60 rotates to push out the scraped wood chips.

The beneficial effect of the invention is that the device can automatically adjust the depth and angle of the planer blade, so that when the woodworker uses the planer, according to the actual situation, the amount of the knife can be automatically adjusted, and then the function of adjusting the angle of the blade can be extended Blade life

At the same time, during the use of the device, the sawdust shaved off by the planer can be discharged out of the device through the removal device, so that the planer is not prone to seizure during use, so that the planer can ensure the use of the planer during work. Fluency.

The above are only specific embodiments of the invention, but the scope of protection of the invention is not limited to this. Any changes or substitutions that are not thought through without creative work should be covered by the scope of protection of the invention. Therefore, the protection scope of the invention shall be subject to the protection scope defined by the claims.

1. A shaving blade with adjustable shaving depth for a high-grade floor, comprising a machine body, characterized in that the machine body is provided with a working cavity penetrating up and down, and an opening space is provided on the right wall of the working cavity. A wheel groove is provided on the bottom side of the body, and a fixed cavity is provided on the left side of the wheel groove, the fixed cavity is in communication with the working cavity, and a communication cavity is communicated between the fixed cavity and the opening space. A removal device for removing wood chips is provided between the open space and the wheel groove;
the removing device includes a wheel shaft rotatably mounted on the front and rear side walls of the wheel groove, a soft wheel is fixed on the wheel shaft, a first bevel gear is fixed on the front side of the wheel shaft, and a bottom wall of the open space is provided. A penetrating shaft is rotatably connected to the top wall of the wheel groove, and a second bevel gear meshing with the first bevel gear is fixed on the bottom side of the penetrating shaft, and the top side of the penetrating shaft is fixed. A third bevel gear, a horizontal axis is rotatably connected to the right wall of the opening space, and a fourth bevel gear meshing with the third bevel gear is fixed on the right side of the horizontal axis, and the left side of the horizontal shaft is fixed A long gear is fixed, a sliding slider is slidably connected in the opening space, a right side of the moving slider is provided with a fixed cavity opening to the right, and a left side of the moving slider is provided with an opening opening to the left. A gear shaft is rotatably connected between the right wall of the discharge cavity and the left wall of the fixed cavity, and an end gear meshing with the long gear is fixed on the right side of the gear shaft, and the gear A seventh bevel gear is fixed on the left side of the shaft, and a rotating shaft is rotatably connected to the front and rear side walls of the discharge cavity. The front side of the rotary shaft is provided with the solid seventh eighth bevel gear of the bevel gear, a rear side of the rotary shaft is provided with six small solid roller;
the fixing cavity is provided with a fixing device for fixing the blade, the left side wall of the working cavity is provided with an auxiliary cavity, the left side of the auxiliary cavity is provided with a driving cavity, and the left side of the driving cavity is provided with a hydraulic pipe. A hydraulic chamber is symmetrically connected to both ends of the hydraulic pipeline, and an adjusting device for adjusting a cutter angle is provided in the hydraulic chamber and the working chamber, and a stabilizing device is provided in the auxiliary chamber to make the adjusting device stable.

2. A shaving blade with adjustable shaving depth for high-grade floors according to claim 1, wherein the fixing device comprises a hydraulic cylinder fixedly installed on the right side wall of the fixing cavity, and the hydraulic pressure A fixed head slidingly connected to the fixed cavity is dynamically connected in the cylinder, and a driving slider slidingly connected to the through cavity is connected between the fixed head and the moving slider.

3. The shaving blade with adjustable shaving depth for high-grade floors according to claim 1, wherein the adjusting device comprises a power motor fixedly installed on the bottom wall of the driving cavity, and the power The motor is powered by a motor shaft, a fifth bevel gear is fixed on the top side of the motor shaft, a water pump is fixed in the hydraulic pipeline, and a water pump shaft is provided in the water pump to drive the water pump to start. A water pump shaft is rotatably connected to the left wall of the driving cavity, a sixth bevel gear meshing with the fifth bevel gear is fixed on the middle side of the water pump shaft, and a cam is fixed on the right side of the water pump shaft. A rotating shaft is rotatably connected to the front and rear side walls of the working cavity, and a fixing plate is fixed on the rotating shaft. A fixing block is symmetrically fixed on the left side of the fixing plate, and each of the fixing blocks is hinged. There is a hydraulic rod, and hydraulic oil is arranged between the hydraulic rods on the upper and lower sides.

4. The shaving blade with adjustable shaving depth for high-grade floors according to claim 1, wherein the stabilization device comprises a ladder block slidingly installed on the bottom wall of the driving cavity, and the ladder block A return spring is connected to the bottom wall of the driving cavity. A driven plate is fixed on the left side of the ladder block, the driven plate is in contact with the cam, and the upper and lower side walls of the auxiliary cavity are symmetrical. A clamping strip is slidably connected, and a compression spring is connected between the clamping strip and the auxiliary cavity. The upper and lower sides of the clamping strip are symmetrically provided with clamping grooves. The limiting block can be slidably connected with the card slot, a limiting spring is connected between the limiting blocks, and the left side wall of the auxiliary cavity and the right side wall of the driving cavity are slidably connected with The clamping block abutted by the ladder block.

5. A shaving blade with adjustable shaving depth for high-grade floors according to claim 3, wherein a soft pad is fixed on the right side of the fixing plate, and the soft pad can fix the blade.

6. The shaving knife with adjustable shaving depth for high-grade floors according to claim 1, wherein the small roller is made of rubber material.

7. The shaving blade with adjustable shaving depth for high-grade floors according to claim 4, wherein the elasticity of the limit spring is smaller than the elasticity of the return spring.

8. The shaving blade with adjustable shaving depth for high-grade floors according to claim 4, wherein the compression spring is always in a compressed state.

9. The shaving blade with adjustable shaving depth for high-grade floors according to claim 1, wherein grips are symmetrically fixed on the front and back sides of the machine body. 10.
